(19) United States
(12) Patent Application Publication
(10) Pub. No.: US 2001/0040934 A1
(43) Pub. Date: Nov. 15, 2001

(54) Synchronization detection apparatus and receiving apparatus and methods of the same

(76) Inventor: Yoshihiro Shoji, Tokyo (JP)

Correspondence Address: FROMMER LAWRENCE & HAUG LLP, 745 FIFTH AVENUE, NEW YORK, NY, 10151, US

(21) Appl. No.: 09/777,454

(22) Filed: Feb. 6, 2001

(30) Foreign Application Priority Data
Feb. 8, 2000 (JP) P2000-035652

(51) Int. Cl. H04L 7/00

(52) U.S. Cl. 375/368; 370/509

(57) ABSTRACT

A synchronization detection apparatus able to quickly detect synchronization words (synchronization patterns) arranged at predetermined bit intervals in a signal, provided with a synchronization word detector for identifying data having the same number of bits as the synchronization pattern in order while shifting positions of data in the signal in units of bits and comparing the identified data with a predetermined synchronization pattern stored beforehand; a consecutive synchronization word detection counter for establishing synchronization using the identified data as the synchronization pattern when all of the comparison results of a predetermined number of data identified and arranged consecutively at predetermined bit intervals are in agreement; a delay unit; and a synchronization processing state judging unit.

### BACKGROUND OF THE INVENTION

1. Field of the Invention

The present invention relates to a synchronization detection apparatus for detecting synchronization patterns arranged at specific bit intervals in a signal, a receiving apparatus, and methods of the same.

2. Description of the Related Art

In order to make it possible to store compressed coded video and voice using the MPEG (Moving Picture Experts Group) standard and apply them to various fields such as communication and broadcasting, effort is being made to set up standards for the method of multiplexing a plurality of MPEG video and voice data streams.

For example, the MPEG2 system defines several bit signal sequences of several programs comprising a plurality of video, voice, and data streams. For example, there are transport streams envisioning use in broadcasting, communication, and other transmission channels where errors occur and program streams envisioning use in storage and other transmission channels free from errors.

Here, a transport stream comprises transport stream packets of a fixed length of 188 bytes having the format shown in FIG. 5.

The header of the transport stream packet shown in FIG. 5 is provided with a 1-byte synchronization word having “47(H)” as its intrinsic value.

In satellite broadcasting etc., the transmitting apparatus processes the transport stream packets shown in FIG. 5 and FIG. 6A by energy spread and Reed-Solomon coding, generates packet data appended with 16-byte parity data as shown in FIG. 6B, interleaves the packet data in unit of byte, maps the convolutional coded data to symbols, then modulates and outputs the result.

The receiving apparatus processes the symbol data demodulated from the received data by Viterbi decoding, detects from the decoded packet data shown in FIG. 6B the 1-byte synchronization word located at the head of 204-byte slot data, and performs various processing in unit of the transport stream packets based on the detected synchronization word.

FIGS. 7A to 7C explain the synchronization detection process in the receiving apparatus. The abscissa indicates time.

FIG. 7A shows the synchronization processing states in the receiving apparatus. There are three states including a synchronization searching state, a synchronization protecting state, and a synchronization establishment state.

The receiving apparatus is in the synchronization searching state from the state where synchronization has not been established to when a synchronization word is detected. In this synchronization searching state, the receiving apparatus constantly monitors the received data to detect a synchronization word. When detecting a synchronization word for the first time, the receiving apparatus shifts from the synchronization searching state to the synchronization protecting state.

The receiving apparatus is in the synchronization protecting state after detecting a synchronization word and remains in this state until detecting a synchronization word two more times successively. In the synchronization protecting state, the receiving apparatus counts one packet length by a packet length counter from the timing of the last detection of the synchronization word and checks if the pattern after one packet length is a synchronization word. If it turns out to be a synchronization word, it increments the synchronization protecting count by one. When the synchronization protecting count reaches three, that is, the receiving apparatus has detected a synchronization word three times, the receiving apparatus shifts to the synchronization establishment state from the synchronization protecting state. On the other hand, if not detecting a synchronization word after one packet length, the receiving apparatus resets the synchronization protecting count to “0” and then shifts from the synchronization protecting state to the synchronization searching state.

In the example shown in FIGS. 7A to 7C, up to the time t1, the receiving apparatus is in the synchronization searching state and is constantly monitoring whether or not a synchronization word is included in the received signal. If it detects a synchronization word at the time t1, the receiving apparatus shifts to the synchronization protecting state. Along with this, the synchronization protecting count becomes “1”.

Next, the receiving apparatus counts the packet length. At the time t2 after which the count of packet length indicates “Max”, that is, at the position 204 bytes after the last-detected synchronization word in the received signal, it checks whether or not there is a synchronization word. If it detects a synchronization word, the receiving apparatus holds the synchronization protecting state and increments the synchronization protecting count to “2”.

Next, the receiving apparatus counts the packet length. At the time t3 after which the count of packet length indicates “Max”, it checks whether or not there is a synchronization word. If it does not detect a synchronization word, the receiving apparatus shifts to a synchronization acquiring state and resets the synchronization protecting count to “0”.

The receiving apparatus constantly monitors whether or not a synchronization word is included in the received signal from the time t3. If detecting a synchronization word at the time t4, the receiving apparatus shifts to the synchronization protecting state and the synchronization protecting count becomes “1”.

Next, the receiving apparatus counts the packet length. At the time t5 after which the count of packet length indicates “Max”, that is, at the position 204 bytes after the last-detected synchronization word in the received signal, it checks whether or not there is a synchronization word. If it detects a synchronization word, the receiving apparatus holds the synchronization protecting state and increments the synchronization protecting count to “2”.

Next, the receiving apparatus counts the packet length. At the time t6 after which the count of packet length is indicates “Max”, that is, at the position 204 bytes after the last-detected synchronization word in the received signal, it checks whether or not there is a synchronization word. If it detects a synchronization word, the receiving apparatus shifts to the synchronization establishment state and increments the synchronization protecting count to “3”. That is, synchronization is established.

Summarizing the problem to be solved by the invention, the synchronization detection method of the receiving apparatus of the related art described above suffered from the problem that in the synchronization protecting state, the synchronization word was not detected until the count of the packet length became “Max”, so when data having the same pattern with the synchronization word happened to exist in the received signal and the data was detected as a synchronization word by mistake, the time before shifting to the synchronization establishment state based on detection of the correct synchronization words, that is, the time before synchronization was established, became very long.

In case of MPEG, the average number of times that a pattern the same as the synchronization word appears in a packet is as explained below.

Since the MPEG synchronization word is a fixed pattern of eight bits, the probability that random data of eight bits will become the same as a synchronization word is 1/256. On the other hand, an MPEG packet has 1632 bits (204 bytes), so if shifting a pattern of eight successive bits one bit each, there are 1632 patterns. Here, if considering the data to be random data, the average number of times that a pattern the same as the synchronization word will appear in a packet will become 6.375 (=1632/256).

FIGS. 8A to 8C explain the problem of the synchronization detection method in the receiving apparatus described above.

As shown in FIGS. 8A to 8C, for example, when the receiving apparatus is in the synchronization searching state, at the time t1, it erroneously detects a pattern in the received signal that is not a correct synchronization word as a synchronization word and shifts to a synchronization protecting state.

Then, the receiving apparatus counts the packet length. At the time t3 after which the count of packet length indicates “Max”, it checks whether or not there is a synchronization word. If it does not detect a synchronization word, the receiving apparatus shifts to the synchronization acquiring state and resets the synchronization protecting count to “0”.

At this time, since the synchronization detection method of the related art does not search for the synchronization word in the interval between the times t1 to t3, it misses the correct synchronization word in the received signal at the time t2.

Next, the receiving apparatus constantly monitors whether or not there is a synchronization word in the received signal from the time t3. At the time t4, it detects a pattern in the received signal that is not a correct synchronization word as a synchronization word by mistake, shifts to a synchronization protecting state, and increments the synchronization protecting count to “1”.

Then, the receiving apparatus counts the packet length. At the time t6 after which the count of packet length indicates “Max”, it detects whether or not there is a synchronization word. If it does not detect a synchronization word, the receiving apparatus shifts to the synchronization acquiring state and resets the synchronization protecting count to “0”.

At this time, since the synchronization detection method of the related art does not search for a synchronization word in the interval of the times t4 to t6, it misses the correct synchronization word in the received signal at the time t5.

Next, the receiving apparatus constantly monitors whether or not there is a synchronization word in the received signal from the time t6. At the time t7, it detects a pattern in the received signal that is not a correct synchronization word as a synchronization word by mistake, shifts to a synchronization protecting state, and increments the synchronization protecting count to “1”.

Then, the receiving apparatus counts the packet length. At the time t9 after which the count of packet length indicates “Max”, it detects whether or not there is a synchronization word. If it does not detect a synchronization word, the receiving apparatus shifts to the synchronization acquiring state and resets the synchronization protecting count to “0”.

At this time, since the synchronization detection method of the related art does not search for a synchronization word in the interval of the times t7 to t9, it misses the correct synchronization word in the received signal at the time t8.

Next, the receiving apparatus constantly monitors whether or not there is a synchronization word in the received signal from the time t9. At the time t10, it finally a correct synchronization word in the received signal, shifts to a synchronization protecting state, and increments the synchronization protecting count to 1.

As explained above, in the synchronization detection method of the related art, in a synchronization searching state, if the receiving apparatus first detects a pattern that is not a correct synchronization word as a synchronization word by mistake, it will shift to a synchronization protecting state for a period corresponding to one packet length. During this period, even if a correct synchronization pattern appears, it cannot detect it. Accordingly, it often takes a very long time before detecting a correct synchronization word and shifting to a correct synchronization protecting state and therefore there is a problem that it is very difficult to establish synchronization quickly.

In addition, there is another problem that the time period before synchronization is established is not uniform.

### SUMMARY OF THE INVENTION

An object of the present invention is to provide a synchronization detection apparatus able to quickly detect a synchronization word (synchronization pattern) in a signal, a receiving apparatus, and methods of the same.

In order to achieve the above object, according to a first aspect of the present invention, there is provided a synchronization detection apparatus for detecting synchronization patterns arranged at specific bit intervals in a signal, comprising a comparison circuit for identifying data having the same number of bits as said synchronization pattern in order while shifting positions of data in said signal in units of bits and comparing the identified data with a predetermined synchronization pattern stored beforehand and a synchronization processing circuit for establishing synchronization by using said identified data as said synchronization pattern when all results of comparisons with a predetermined number of the identified data arranged successively at said specific bit intervals are in agreement.

The functions of the synchronization detection apparatus according to the first aspect of the present invention are as follows.

The comparison circuit identifies data having the same number of bits as the synchronization pattern in order while shifting positions of data in the signal in units of bits and compares the identified data with a predetermined synchronization pattern stored beforehand.

Then, the synchronization processing circuit receives the comparison results of the comparison circuit. When all results of comparisons with a predetermined number of the identified data arranged successively at said specific bit intervals are in agreement, it establishes synchronization by using the identified data as the synchronization pattern.

In this way, in the synchronization detection apparatus according to the first aspect of the present invention, the comparison circuit continues comparing data even after the comparison results of the comparison circuit are in agreement.

Consequently, the problem of the comparison circuit missing a correct synchronization pattern can be avoided.

According to a second aspect of the present invention, there is provided a synchronization detection apparatus for detecting synchronization patterns arranged at specific bit intervals in a signal, comprising a comparison circuit for identifying data having the same number of bits as the synchronization pattern in order while shifting positions of data in the signal in units of bits and comparing the identified data with a predetermined synchronization pattern stored beforehand, a count circuit for adding or subtracting a predetermined value to or from an input first count to generate a second count when comparison results of said comparison circuit are in agreement, a delay circuit for receiving as input the second count, delaying the second count by a time corresponding to the specific bit interval, and outputting the second count as the first count, and a synchronization processing state judgement circuit for judging whether or not synchronization is established based on the second count.

The functions of the synchronization detection apparatus according to the second aspect of the present invention are as follows.

The comparison circuit identifies data having the same number of bits as the synchronization pattern in order while shifting positions of data in the signal in units of bits and compares the identified data with a predetermined synchronization pattern stored beforehand.

The count circuit adds or subtracts a predetermined value to or from an input first count to generate a second count when the comparison results of the comparison circuit are in agreement.

The second count is input into the delay circuit where it is delayed by a time corresponding to the specific bit interval and then is output to said count circuit as the first count.

The synchronization processing state judgement circuit judges whether or not synchronization is established based on the second count.

In addition, in the synchronization detection apparatus according to the second aspect of the present invention, preferably the comparison circuit includes a shift register having the same number of bits as said synchronization pattern and shifts said signal and compares data stored in the shift register with a predetermined synchronization pattern stored beforehand.

In addition, in the synchronization detection apparatus according to the second aspect of the present invention, preferably the delay circuit is a first-in first-out (FIFO) circuit having a bit length corresponding to the specific bit interval and outputs the input second count as the first count in order of input.

In addition, in the synchronization detection apparatus according to the second aspect of the present invention, preferably the count circuit sets an initial value for the second count when the comparison results of the comparison circuit are not in agreement.

In addition, in the synchronization detection apparatus according to the second aspect of the present invention, preferably the signal comprises a plurality of packets each having a specific bit length, and the synchronization pattern is located at the head of a packet.

In addition, according to a third aspect of the present invention, there is provided a receiving apparatus comprising a synchronization detection circuit for detecting synchronization patterns arranged at specific bit intervals in a received signal and generating a synchronization signal and a circuit for processing the received signal based on the synchronization signal, wherein said synchronization detection circuit comprises a comparison circuit for identifying data having the same number of bits as the synchronization pattern in order while shifting positions of data in the received signal in units of bits and comparing the identified data with a predetermined synchronization pattern stored beforehand and a synchronization processing circuit for generating a synchronization signal using the identified data as the synchronization pattern when all results of the comparisons with a predetermined number of the identified data arranged successively at said specific bit intervals are in agreement.

In addition, according to a fourth aspect of the present invention, there is provided a receiving apparatus comprising a synchronization detection circuit for detecting synchronization patterns arranged at specific bit intervals in a received signal and generating a synchronization signal and a circuit for processing the received signal based on the synchronization signal, wherein the synchronization detection circuit comprises a comparison circuit for identifying data having the same number of bits as the synchronization pattern in order while shifting positions of data in the received signal in units of bits and comparing the identified data with a predetermined synchronization pattern stored beforehand, a count circuit for adding or subtracting a specific value to or from an input first count to generate a second count when results of comparisons of the comparison circuit are in agreement, a delay circuit for receiving as input the second count, delaying the second count by a time corresponding to the specific bit interval, and outputting the second count as the first count, and a synchronization processing state judgement circuit for judging whether or not synchronization is established based on the second count.

In addition, according to a fifth aspect of the present invention, there is provided a synchronization detection method for detecting synchronization patterns arranged at specific bit intervals in a signal, comprising the steps of identifying data having the same number of bits as the synchronization pattern in order while shifting positions of data in the signal in units of bits, comparing the identified data with a predetermined synchronization pattern stored beforehand, and using the identified data as the synchronization pattern to establish synchronization when all results of comparisons with a predetermined number of the identified data arranged successively at said specific bit intervals are in agreement.

In addition, according to a sixth aspect of the present invention, there is provided a synchronization detection method for detecting a synchronization pattern arranged at specific bit intervals in a signal, comprising the steps of identifying data having the same number of bits as the synchronization pattern in order while shifting positions of data in the signal in units of bits, comparing the identified data with a predetermined synchronization pattern stored beforehand, adding or subtracting a specific value to or from a first count to generate a second count when comparison results of said comparison circuit are in agreement, using the second count delayed by a time corresponding to said specific bit intervals as the first count, and judging whether or not synchronization is established based on the second count.

In addition, according to a seventh aspect of the present invention, there is provided a receiving method for detecting synchronization patterns arranged at specific bit intervals in a received signal, generating a synchronization signal, and processing the received signal based on the synchronization signal, comprising the steps of identifying data having the same number of bits as the synchronization pattern in order while shifting positions of data in said received signal in units of bits, comparing the identified data with a predetermined synchronization pattern stored beforehand, using the identified data as the synchronization pattern, and generating a synchronization signal when all results of comparisons with a predetermined number of the identified data arranged successively at said specific bit intervals are in agreement.

### BRIEF DESCRIPTION OF THE DRAWINGS

These and other objects and features of the present invention will become clearer from the following description of the preferred embodiments given with reference to the accompanying drawings, in which:

FIG. 1 is a view of the configuration of a receiving apparatus according to the present embodiment;

FIG. 2 is a view of the configuration of a synchronization detection circuit shown in FIG. 1;

FIG. 3 illustrates the functions of each circuit of the synchronization detection circuit shown in FIG. 2;

FIGS. 4A to 4C show examples of operation of the synchronization detection circuit shown in FIG. 2 and FIG. 3;

FIG. 5 shows the format of an MPEG transport stream packet;

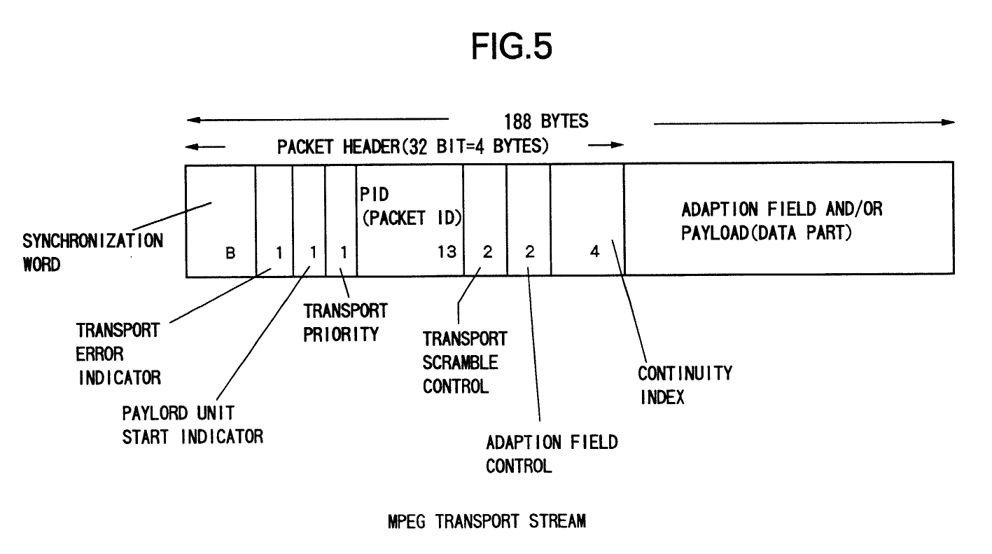

FIGS. 6A and 6B illustrate the slot data included in a signal transmitted or received in satellite broadcasting etc.;

FIGS. 7A to 7C show a synchronization processing method of the related art; and

FIGS. 8A to 8C show the problems of a synchronization process method of the related art.

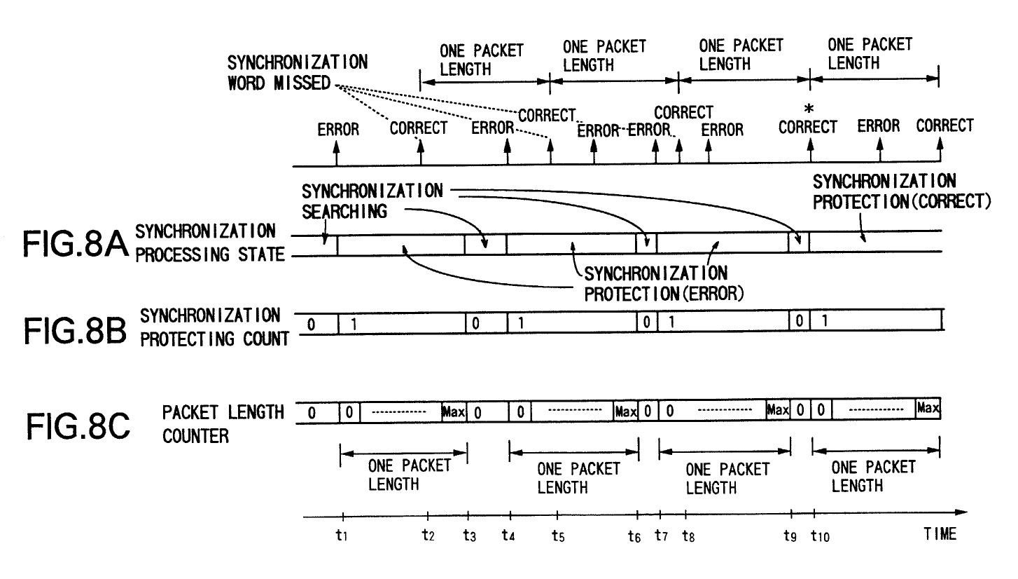

### DESCRIPTION OF THE PREFERRED EMBODIMENTS

Below, a receiving apparatus according to a preferred embodiment of the present invention will be described with reference to the accompanying drawings.

The receiving apparatus according to the preferred embodiment, for example, receives a signal from a satellite broadcasting or communication system etc.

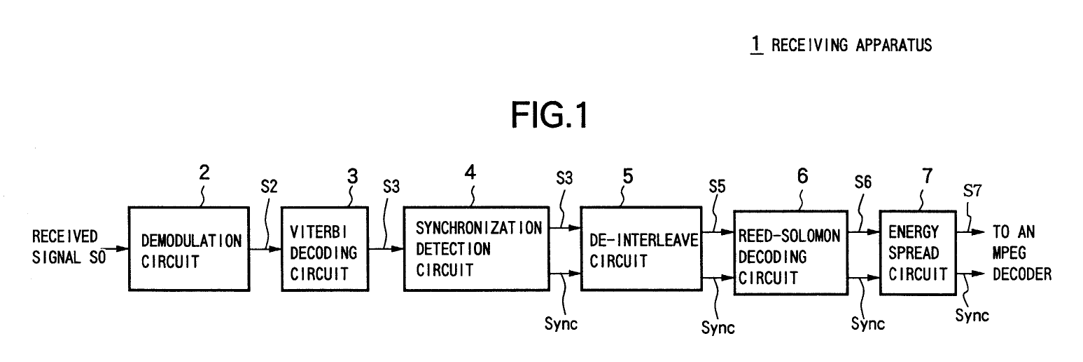

FIG. 1 is a view of the configuration of a receiving apparatus according to the present embodiment.

As shown in FIG. 1, the receiving apparatus 1, for example, comprises a demodulation circuit 2, Viterbi decoding circuit 3, synchronization detection circuit 4, de-interleave circuit 5, Reed-Solomon decoding circuit 6, and energy reverse spread circuit 7.

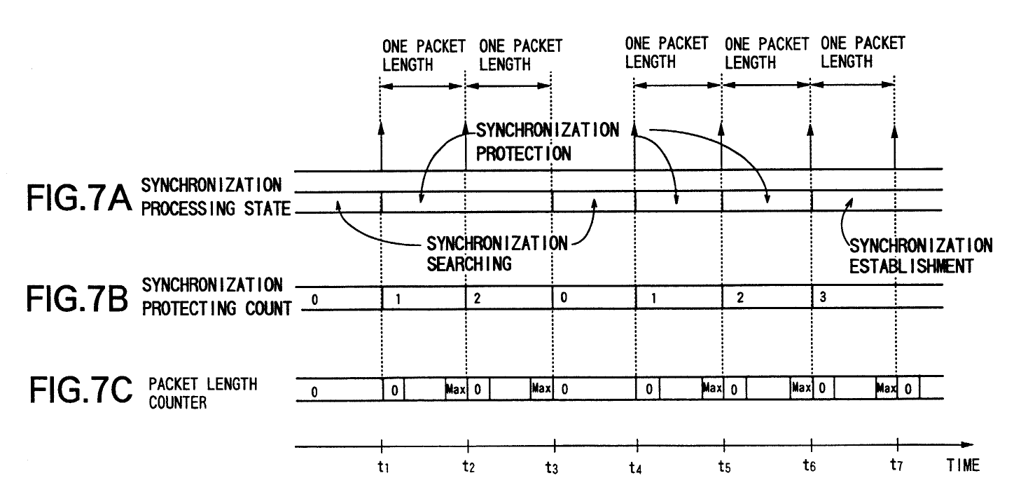

The demodulation circuit 2 demodulates a received signal S0 as shown in FIG. 7B to generate a signal S2 which it outputs to the Viterbi decoding circuit 3.

The Viterbi decoding circuit 3 decodes the signal S2 input from the demodulation circuit 2 to generate a signal S3 which it outputs to the synchronization detection circuit 4.

The synchronization detection circuit 4 detects synchronization of the signal S3 input from the Viterbi decoding circuit 3 to generate a synchronization signal Sync and outputs the synchronization signal Sync and signal S3 to the de-interleave circuit 5.

The configuration and processing of the synchronization detection circuit 4 will be described later.

Based on the synchronization signal Sync input from the synchronization detection circuit 4, the de-interleave circuit 5 de-interleaves the signal S3 input from the synchronization detection circuit 4 to generate a signal S5 and outputs the synchronization signal Sync and the signal S5 to the Reed-Solomon decoding circuit 6.

Based on the synchronization signal Sync input from the de-interleave circuit 5, the Reed-Solomon circuit 6 decodes (204, 188) the signal S5 input from the de-interleave circuit 5 to generate a signal S6 and outputs the synchronization signal Sync and signal S6 into the energy reverse spread circuit 7.

The energy reverse spread circuit 7 processes the signal S6 input from the Reed-Solomon decoding circuit to generate a signal S7 and outputs the synchronization signal Sync and signal S7 to a later MPEG decoder.

Next, the synchronization detection circuit shown in FIG. 1 will be explained.

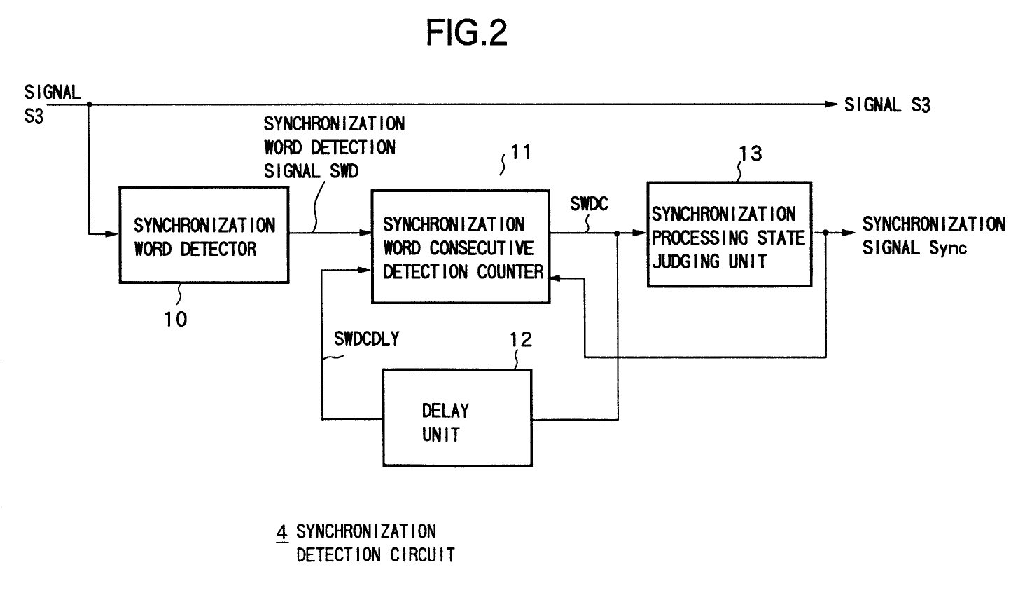

FIG. 2 shows the configuration of the synchronization detection circuit shown in FIG. 1.

As shown in FIG. 2, the synchronization detection circuit, for example, comprises a synchronization word detector 10, synchronization word consecutive detection counter 11, delay unit 12, and synchronization processing state judging unit 13.

Here, the synchronization word detector 10 corresponds to the comparison circuit of the present invention.

In addition, the synchronization word consecutive detection counter 11, delay unit 12, and synchronization processing state judging unit 13 correspond to the synchronization processing circuit in claim 1 etc. of the present invention.

In addition, the synchronization word consecutive detection counter 11 corresponds to the count circuit in claim 3 of the present invention, the delay unit 12 to the delay circuit in claim 3, and the synchronization processing state judging unit 13 to the synchronization processing state judgement circuit.

In addition, the count of the consecutive synchronization word detection count signal SWDC corresponds to the second count of the present invention, while the count of the delayed consecutive synchronization word detection count signal SWDCDLY corresponds to the first count of the present invention.

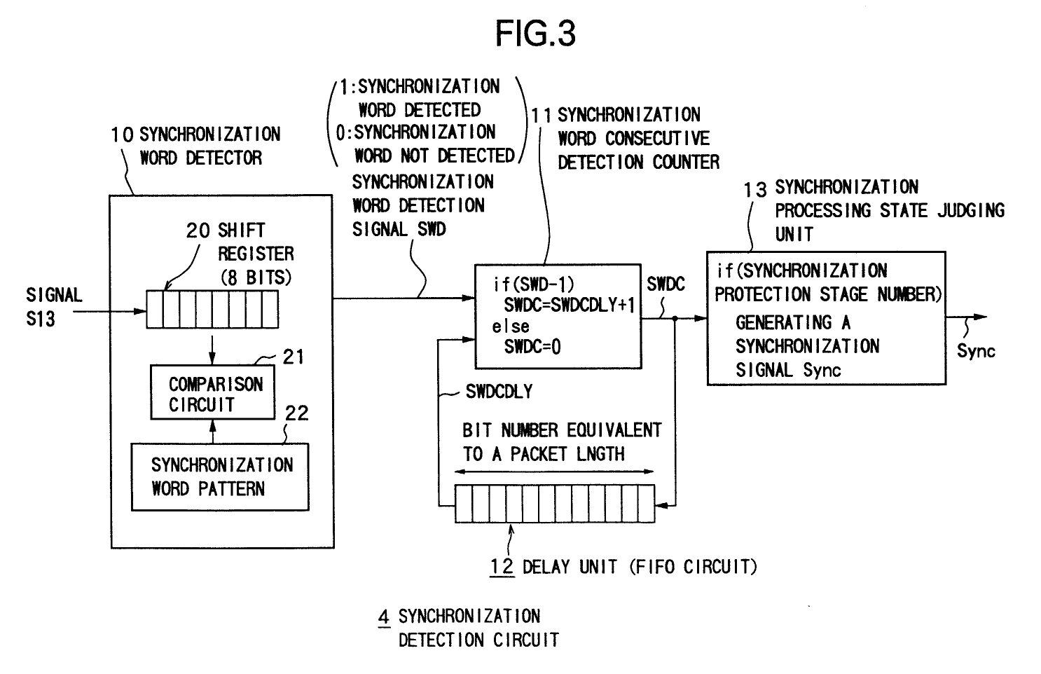

The synchronization word detector 10, for example, as shown in FIG. 3, has an eight-bit shift register 20 that shifts the signal S3 in order of input from the Viterbi decoding circuit 3 shown in FIG. 1. The comparison circuit 21 compares an eight-bit pattern stored in the shift register with a predetermined synchronization word pattern 22 stored in a register beforehand. When they are in agreement, it generates a synchronization word detection signal SWD including a pulse rising at this time and inputs it to the synchronization word consecutive detection counter 11.

The synchronization word consecutive detection counter 11 receives as input the synchronization word detection signal SWD from the synchronization word detector 10 and receives as input a delayed consecutive synchronization word detection count signal SWDCDLY representing the consecutive synchronization word detection count at the time one packet before from the delay unit 12.

The synchronization word consecutive detection counter 11, for example, in the interval when the signal S13 is shifted in the shift register 20 of the synchronization word detector 10, judges whether or not the synchronization word detection signal SWD represents logic “1”, namely, judges whether or not a pulse has occurred in the synchronization word detection signal SWD.

If it judges that the synchronization word detection signal SWD represents the logic “1”, the synchronization word consecutive detection counter 11 sets the count represented by the consecutive synchronization word detection count signal SWDC to the count represented by the delayed consecutive synchronization word detection count signal SWDCDLY input from the delay unit 12 incremented by exactly “1”. In other cases, it sets the count represented by the consecutive synchronization word detection count signal SWDC to “0”.

The synchronization word consecutive detection counter 11 outputs the consecutive synchronization word detection count signal SWDC to the delay unit 12 and the synchronization processing state judging unit 13.

The delay unit 12, for example, is an FIFO circuit equivalent to one packet length (2048×8 bits long). It outputs to the synchronization word consecutive detection counter 11 in the order of input the consecutive synchronization word detection count signal SWDC input from the synchronization word consecutive detection counter 11 as the delayed consecutive synchronization word detection count signal SWDCDLY.

Here, the count represented by the delayed consecutive synchronization word detection count signal SWDCDLY is the same as the consecutive synchronization word detection count signal SWDC at the time one packet before.

The synchronization processing state judging unit 13 monitors the count of the consecutive synchronization word detection count signal SWDC input from the synchronization word consecutive detection counter 11 and judges whether or not the count is the the number of the stage of synchronization protection (for example, “3” in the present embodiment). If it is, it generates a pulse to the synchronization signal Sync.

The synchronization processing state judging unit 13 outputs the synchronization signal Sync to the de-interleave circuit 5 shown in FIG. 1.

Next, an example of the synchronization detection circuit 4 shown in FIG. 2 and FIG. 3 will be explained.

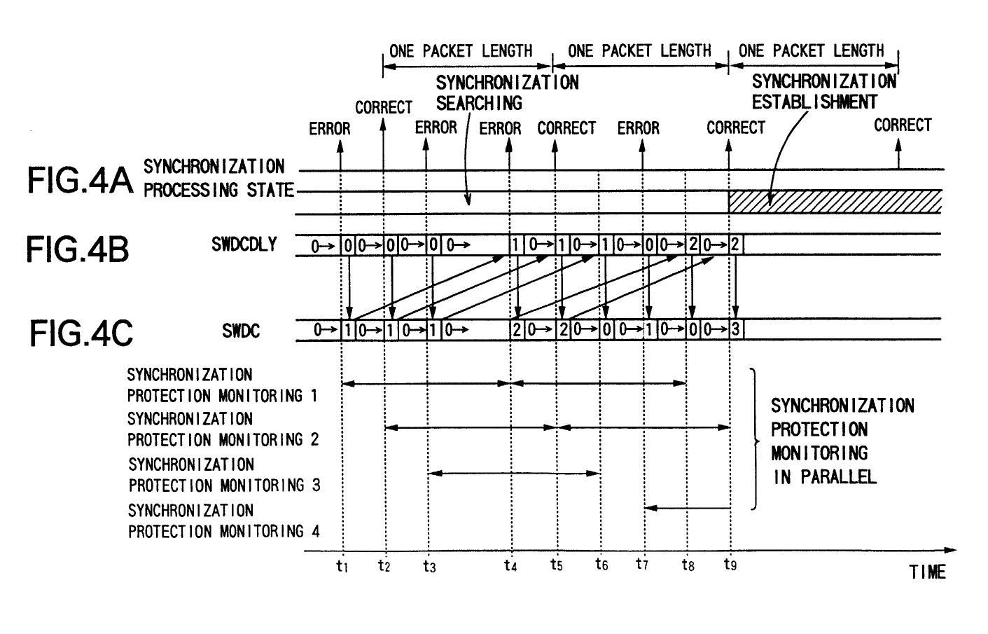

FIGS. 4A to 4C show an example of the operation of the synchronization detection circuit 4.

In the example shown in FIGS. 4A to 4C, at the times t1, t3, t4, and t7, the data in the signal S13 input to the synchronization detection circuit 4 is not a correct synchronization word, but has the same pattern with the synchronization word.

In addition, at the times t2, t5, and t9, a signal S13 including a synchronization word is input into the synchronization detection circuit 4.

[Up to Time t1]

The synchronization word detector 10 does not detect the first synchronization word. The synchronization word detection signal SWD continues to represent the logic Accordingly, the consecutive synchronization word detection count signal SWDC output from the synchronization word consecutive detection counter 11 to the synchronization processing state judging unit 13 also continues to represent the logic “1”, while the synchronization signal Sync output from the synchronization processing state judging unit 13 also represents the logic “0”. The logic values of the consecutive synchronization word detection count signal SWDC shifted in the delay unit 12 are all “0”.

[From Time t1 to t2]

At the time t1, the synchronization word detector 10 detects a pattern that is included in the signal S13 and is not the correct synchronization pattern (pattern happening to be same with the synchronization word) by mistake as a synchronization word and generates a pulse in the synchronization word detection signal SWD.

Then, the synchronization word consecutive detection counter 11 adds “1” to the logic “0” of the initial state represented by the delayed consecutive synchronization word detection count signal SWDCDLY and outputs the consecutive synchronization word detection count signal SWDC representing a count of “1” to the delay unit 12 and the synchronization processing state judging unit 13.

Then, until the time t2, the synchronization word detector 10 continues to detect the synchronization words, but does not detect any pattern the same with the synchronization pattern. The synchronization word detection signal SWD continues to represent the logic value “0”, and the count represented by the consecutive synchronization word detection count signal SWDC maintains the logic “0”.

During this period, at the time t1, the logic “1” represented by the consecutive synchronization word detection count signal SWDC input into the delay unit 12 is shifted successively toward the output side in the delay unit 12.

In addition, after the time t1 and before the time t2, the logic “0” represented by the consecutive synchronization word detection count signal SWDC input into the delay unit 12 is also shifted successively toward the output side in the delay unit 12.

[Time t2 to t3]

At the time t2, the synchronization word detector 10 detects a correct synchronization pattern included in the signal S13 and generates a pulse in the synchronization word detection signal SWD.

Then, the synchronization word consecutive detection counter 11 adds “1” to the logic “0” of the initial state represented by the delayed consecutive synchronization word detection count signal SWDCDLY and outputs the consecutive synchronization word detection count signal SWDC representing a count of “1” to the delay unit 12 and the synchronization processing state judging unit 13.

Then, until the time t3, the synchronization word detector 10 continues to detect the synchronization words, but does not detect any pattern the same with the synchronization pattern. The synchronization word detection signal SWD continues to represent the logic value “0”, and the count represented by the consecutive synchronization word detection count signal SWDC maintains the logic “0”.

During this period, at the time t2, the logic “1” represented by the consecutive synchronization word detection count signal SWDC input into the delay unit 12 is shifted successively toward the output side in the delay unit 12.

In addition, after the time t2 and before the time t3, the logic “0” represented by the consecutive synchronization word detection count signal SWDC input into the delay unit 12 is also shifted successively toward the output side in the delay unit 12.

[Time t3 to t4]

At the time t3, the synchronization word detector 10 detects a pattern that is included in the signal S13 and is not the correct synchronization pattern by mistake as a synchronization word and generates a pulse in the synchronization word detection signal SWD.

Then, the synchronization word consecutive detection counter 11 adds “11” to the logic “0” of the initial state represented by the delayed consecutive synchronization word detection count signal SWDCDLY and outputs the consecutive synchronization word detection count signal SWDC representing a count of “1” to the delay unit 12 and the synchronization processing state judging unit 13.

Then, until the time t4, the synchronization word detector 10 continues to detect the synchronization words, but does not detect any pattern the same with the synchronization pattern. The synchronization word detection signal SWD continues to represent the logic value “0”, and the count represented by the consecutive synchronization word detection count signal SWDC maintains the logic “0”.

During this period, at the time t3, the logic “1” represented by the consecutive synchronization word detection count signal SWDC input into the delay unit 12 is shifted successively toward the output side in the delay unit 12.

In addition, after the time t3 and before the time t4, the logic “0” represented by the consecutive synchronization word detection count signal SWDC input into the delay unit 12 is also shifted successively toward the output side in the delay unit 12.

[Time t4 to t5]

At the time t4, the synchronization word detector 10 detects a pattern that is included in the signal S13 and is not the correct synchronization pattern by mistake as a synchronization word and generates a pulse in the synchronization word detection signal SWD.

At this time, the logic “1” represented by the consecutive synchronization word detection count signal SWDC input into the delay unit 12 at the time t1 is output from the delay unit to the synchronization word consecutive detection counter 11 as the delayed consecutive synchronization word detection count signal SWDCDLY.

Then, the synchronization word consecutive detection counter 11 adds “1” to the logic “1” of the initial state represented by the delayed consecutive synchronization word detection count signal SWDCDLY and outputs the consecutive synchronization word detection count signal SWDC representing a count of “2” to the delay unit 12 and the synchronization processing state judging unit 13.

Then, until the time t5, the synchronization word detector 10 continues to detect the synchronization words, but does not detect any pattern the same with the synchronization pattern. The synchronization word detection signal SWD continues to represent the logic value “0”, and the count represented by the consecutive synchronization word detection count signal SWDC maintains the logic “0”.

During this period, at the time t4, the logic “2” represented by the consecutive synchronization word detection count signal SWDC input into the delay unit 12 is shifted successively toward the output side in the delay unit 12.

In addition, after the time t4 and before the time t5, the logic “0” represented by the consecutive synchronization word detection count signal SWDC input into the delay unit 12 is also shifted successively toward the output side in the delay unit 12.

[Time t5 to t6]

At the time t5, the synchronization word detector 10 detects a correct synchronization pattern included in the signal S13 and generates a pulse in the synchronization word detection signal SWD.

At this time, the logic “1” represented by the consecutive synchronization word detection count signal SWDC input into the delay unit 12 at the time t2 is output from the delay unit to the synchronization word consecutive detection counter 11 as the delayed consecutive synchronization word detection count signal SWDCDLY.

Then, the synchronization word consecutive detection counter 11 adds the logic “1” to logic value “1” represented by the delayed consecutive synchronization word detection count signal SWDCDLY and outputs the consecutive synchronization word detection count signal SWDC representing a count of “2” to the delay unit 12 and the synchronization processing state judging unit 13.

Then, until the time t6, the synchronization word detector 10 continues to detect the synchronization words, but does not detect any pattern the same with the synchronization pattern. The synchronization word detection signal SWD continues to represent the logic value “0”, and the count represented by the consecutive synchronization word detection count signal SWDC maintains the logic “0”.

During this period, at the time t5, the logic “2” represented by the consecutive synchronization word detection count signal SWDC input into the delay unit 12 is shifted successively toward the output side in the delay unit 12.

In addition, after the time t5 and before the time t6, the logic “0” represented by the consecutive synchronization word detection count signal SWDC input into the delay unit 12 is also shifted successively toward the output side in the delay unit 12.

[Time t6 to t7]

At the time t6, the logic value “1” represented by the delayed consecutive synchronization word detection count signal SWDCDLY (logic value “1” input to the delay unit 12 from the synchronization word consecutive detection counter 11) is input from the delay unit 12 to the synchronization word consecutive detection counter 11. At this time, since the synchronization word detector 10 does not detect a synchronization pattern and the synchronization word detection signal SWD represents the logic value “0”, the consecutive synchronization word detection count signal SWDC representing a value of logic “0” is output to the delay unit 12 and the synchronization processing state judging unit 13.

In addition, after the time t6 and before the time t7, a logic “0” represented by the consecutive synchronization word detection count signal SWDC input into the delay unit 12 is also shifted successively toward the output side in the delay unit 12.

[Time t7 to t8]

At the time t7, the synchronization word detector 10 detects a pattern that is included in the signal S13 and is not the correct synchronization pattern by mistake as a synchronization word and generates a pulse in the synchronization word detection signal SWD.

Then, the synchronization word consecutive detection counter 11 adds “1” to the logic “0” of the initial state represented by the delayed consecutive synchronization word detection count signal SWDCDLY and outputs the consecutive synchronization word detection count signal SWDC representing a count of “1” to the delay unit 12 and the synchronization processing state judging unit 13.

Then, after the time t7 and before the time t8, the logic “0” represented by the consecutive synchronization word detection count signal SWDC input into the delay unit 12 is also shifted successively toward the output side in the delay unit 12.

[Time t8 to t9]

At the time t8, the logic value “2” represented by the delayed consecutive synchronization word detection count signal SWDCDLY (logic value “2” input to the delay unit 12 from the synchronization word consecutive detection counter 11) is input from the delay unit 12 to the synchronization word consecutive detection counter 11. At this time, since the synchronization word detector 10 does not detect a synchronization pattern and the synchronization word detection signal SWD represents logic value “0”, the consecutive synchronization word detection count signal SWDC representing a value of logic “0” is output into the delay unit 12 and the synchronization processing state judging unit 13.

[From Time t9 on]

At the time t9, the synchronization word detector 10 detects a correct synchronization pattern included in the signal S13 and generates a pulse in the synchronization word detection signal SWD.

Then, the synchronization word consecutive detection counter 11 adds a logic “1” to the logic value “2” represented by the delayed consecutive synchronization word detection count signal SWDCDLY and outputs the consecutive synchronization word detection count signal SWDC representing a count of “3” to the delay unit 12 and the synchronization processing state judging unit 13.

Consequently, the synchronization processing state judging unit 13 judges that the count represented by the consecutive synchronization word detection count signal SWDC becomes the number “3” of the stage of synchronization protection, the synchronization processing state judging unit 13 shifts from the synchronization searching state to the synchronization establishment state, and a pulse is generated at the synchronization signal Sync.

As explained above, according to the synchronization detection circuit 4, the synchronization word detector 10 continues to detect synchronization words even after detecting a synchronization word, while the synchronization word consecutive detection counter 11 increments the count of the delayed consecutive synchronization word detection count signal SWDCDLY that represents the count of the consecutive synchronization word detection count signal SWDC one packet before when the synchronization word detection signal SWD is the logic “1”.

Therefore, according to the synchronization detection circuit 4, the first time when data having the same pattern with a synchronization word is generated successively for the number of times equal to the number of stages of synchronization protection at intervals of 204 bytes can be reliably identified and the problem of missing detection of this time as explained in the related art can be reliably avoided.

As a result, according to the synchronization detection circuit 4, the time for establishing synchronization of a received signal is able to be reduced and a synchronization word is able to be made of a smaller number of bits.

In addition, according to the synchronization detection circuit 4, the above functions can be realized with a circuit configuration of a relatively smaller scale.

Next, the overall operation of the receiving apparatus shown in FIG. 1 will be explained.

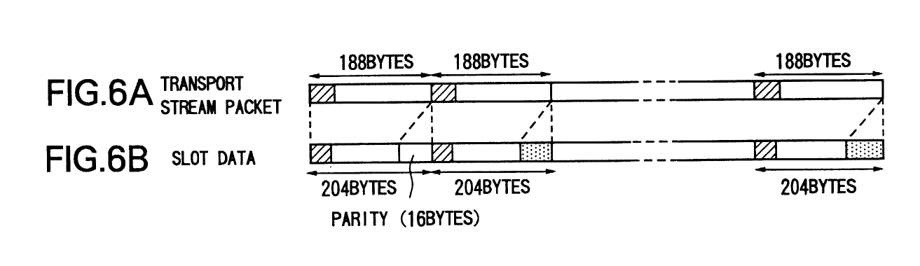

The demodulation circuit 2 demodulates a received signal S0 including slot data as shown in FIG. 6B to generate a signal S2 which is output to the Viterbi decoding circuit 4.

Next, the Viterbi decoding circuit 3 decodes the signal S2 to generate a signal S3 which is output to the synchronization detection circuit 4.

Next, the synchronization detection circuit 4 shown in FIG. 2 and FIG. 3 detects synchronization for the signal S3 to generate a synchronization signal Sync and outputs the synchronization signal Sync and signal S3 to the de-interleave circuit 5.

Next, the de-interleave circuit 5 de-interleaves the signal S3 to generate a signal S5 based on the synchronization signal Sync and outputs the synchronization signal Sync and the signal S5 to the Reed-Solomon decoding circuit 6.

Next, the Reed-Solomon circuit 6 decodes (204, 188) the signal S5 to generate a signal S6 based on the synchronization signal Sync and outputs the synchronization signal Sync and signal S6 to the energy reverse spread circuit 7.

Next, the energy reverse spread circuit 7 processes the signal S6 to generate a signal S7 and outputs the synchronization signal Sync and the signal S7 to a later MPEG decoder etc.

The present invention is not limited to the embodiment described above.

For example, in the embodiment described above, although the example of processing a received signal S0 was explained with reference to an MPEG packet including slot; data as shown in FIG. 6B, the signal handled by the present invention is not particularly limited so long as synchronization patterns are arranged at specific bit intervals in the signal.

Summarizing the effects of the present invention, as explained above, according to the present invention, a synchronization detection apparatus capable of quickly detecting synchronization words (synchronization patterns) included in a signal and a method thereof are able to be provided.

In addition, according to the present invention, a receiving apparatus capable of quickly detecting the synchronization words (synchronization patterns) included in a received signal and a method thereof are able to be provided.

What is claimed is:

1. A synchronization detection apparatus for detecting synchronization patterns arranged at specific bit intervals in a signal, comprising:
a comparison circuit for identifying data having the same number of bits as the synchronization pattern in order while shifting positions of data in the signal in units of bits and comparing the identified data with a predetermined synchronization pattern stored beforehand and
a synchronization processing circuit for establishing synchronization by using the identified data as the synchronization pattern when all results of comparisons with a predetermined number of the identified data arranged successively at said specific bit intervals are in agreement.

2. A synchronization detection apparatus as set forth in claim 1, wherein
said signal comprises a plurality of packets each having a specific bit length, and
said synchronization pattern is arranged at the head of a packet.

3. A synchronization detection apparatus for detecting synchronization patterns arranged at specific bit intervals in a signal, comprising:
a comparison circuit for identifying data having the same number of bits as the synchronization pattern in order while shifting positions of data in the signal in units of bits and comparing the identified data with a predetermined synchronization pattern stored beforehand;
a count circuit for adding or subtracting a predetermined value to or from an input first count to generate a second count when comparison results of said comparison circuit are in agreement;
a delay circuit for receiving as input the second count, delaying the same by a time corresponding to said specific bit intervals, and outputting the same as the first count; and
a synchronization processing state judging circuit for judging whether or not synchronization has been established based on the second count.

4. A synchronization detection apparatus as set forth in claim 3, wherein said comparison circuit
comprises a shift register comprising the same number of bits as said synchronization pattern and shifting said signal and
compares data stored in the shift register with a predetermined synchronization pattern stored beforehand.

5. A synchronization detection apparatus as set forth in claim 3, wherein
said delay circuit is an FIFO circuit having a bit length corresponding to said specific bit interval, and
said input second count is output as said first count in the order of input.

6. A synchronization detection apparatus as set forth in claim 3, wherein said count circuit sets an initial value as the second count when comparison results of said comparison circuit are not in agreement.

7. A synchronization detection apparatus as set forth in claim 3, wherein
said signal comprises a plurality of packets each having a specific bit length, and
said synchronization pattern is arranged at the head of said packet.

8. A receiving apparatus comprising a synchronization detection circuit for detecting synchronization patterns arranged at specific bit intervals in a received signal and generating a synchronization signal and a circuit for processing the received signal based on the synchronization signal,
wherein said synchronization detection circuit comprises:
a comparison circuit for identifying data having the same number of bits as the synchronization pattern in order while shifting positions of data in the received signal in units of bits and comparing the identified data with a predetermined synchronization pattern stored beforehand and
a synchronization processing circuit for generating said synchronization signal by using the identified data as the synchronization pattern when all results of said comparisons with a predetermined number of the identified data arranged successively at said specific bit intervals are in agreement.

9. A receiving apparatus comprising a synchronization detection circuit for detecting synchronization patterns arranged at specific bit intervals in a received signal and generating a synchronization signal and a circuit for processing the received signal based on the synchronization signal,
wherein said synchronization detection circuit comprises:
a comparison circuit for identifying data having the same number of bits as the synchronization pattern in order while shifting positions of data in the received signal in units of bits and comparing the identified data with a predetermined synchronization pattern stored beforehand;
a count circuit for adding or subtracting a specific value to or from an input first count to generate a second count when results of said comparisons of said comparison circuit are in agreement;
a delay circuit for receiving as input the second count, delaying the same by a time corresponding to said specific bit interval, and outputting the same as the first count; and
a synchronization processing state judging circuit for judging whether or not synchronization has been established based on the second count.

10. A synchronization detection method for detecting synchronization patterns arranged at specific bit intervals in a signal, comprising the steps of:
identifying data having the same number of bits as the synchronization pattern in order while shifting positions of data in the signal in units of bits;
comparing the identified data with a predetermined synchronization pattern stored beforehand; and
using the identified data as the synchronization pattern and establishing synchronization when all results of comparisons with a predetermined number of the identified data arranged successively at said specific bit intervals are in agreement.

11. A synchronization detection method for detecting a synchronization pattern arranged at specific bit intervals in a signal, comprising the steps of:
identifying data having the same number of bits as the synchronization pattern in order while shifting positions of data in the signal in units of bits;
comparing the identified data with a predetermined synchronization pattern stored beforehand;
adding or subtracting a specific value to or from a first count to generate a second count when comparison results of said comparison circuit are in agreement;
using the second count delayed by a time corresponding to said specific bit interval as the first count; and
judging whether or not synchronization has been established based on the second count.

12. A receiving method for detecting synchronization patterns arranged at specific bit intervals in a received signal, generating a synchronization signal, and processing the received signal based on the synchronization signal, comprising the steps of:
identifying data having the same number of bits as the synchronization pattern in order while shifting positions of data in said received signal in units of bits;
comparing the identified data with a predetermined synchronization pattern stored beforehand; and
using the identified data as the synchronization pattern and generating said synchronization signal when all results of comparisons with a predetermined number of the identified data arranged successively at said specific bit intervals are in agreement.
